(19) United States
(12) Patent Application Publication
(10) Pub. No.: US 2016/0245980 A1
(43) Pub. Date: Aug. 25, 2016

(54) Light Guide Plate, Backlight Module, and Liquid Crystal Display Device

(71) Applicant: Shenzhen China Star Optoelectronics Technology Co. Ltd., Shenzhen, Guangdong (CN)

(72) Inventor: Hu HE, (US)

(21) Appl. No.: 14/232,611

(22) PCT Filed: Dec. 24, 2013
(86) PCT No.: PCT/CN2013/090346

§ 371 Date: Jan. 13, 2014

(30) Foreign Application Priority Data
Dec. 20, 2013 (CN) 201310706875.9

(51) Int. Cl. F21V 8/00

(52) U.S. Cl. CPC G02B 6/0038; G02B 6/0091

(57) ABSTRACT

The present invention provide a light guide plate and it includes an incident light surface for receiving a light beam projected therein, and a light exiting surface for directing the light beam out of the light guide plate, and a bottom surface opposite to the incident slight surface, wherein the incident light surface is perpendicular to the light exiting surface, and the light exiting surface is provided with a plurality of grooves, wherein the light guide plate further comprises a pair of side surfaces arranged on both sides of the light exiting surface, and the side surfaces are perpendicular to the incident light surface, wherein a longitudinal direction of the side surfaces is same as a direction of the grooves, and a distance between the side surfaces and the bottom surface is smaller than a distance between the light exiting surface and the bottom surface. The present invention further provides a backlight module and a liquid crystal display device incorporated with such a light guide plate.

### FIELD OF THE INVENTION

The present invention relates to the technology of liquid crystal display device, and more particularly, to a liquid crystal display device which is equipped with a light guide plate, backlight module and liquid crystal display device which can effectively prevent leakage of light.

### DESCRIPTION OF PRIOR ART

The liquid crystal display device is featured with slim and compact, lower energy exhaustion, and low radiation, as a result, it has been widely applied and becomes the main stream of the display device. No matter is it notebook computers, mobile phones, or even to the domestic televisions, the liquid crystal display display devices have been widely involved into our daily life. However, since the liquid crystal cannot illuminate all by itself, a backlight module in which a light source is provided to project light beam to a liquid crystal display panel. Then, images can be properly displayed on the liquid crystal display device.

With the advancement of the technology of the liquid crystal display device as well as the strictly regulated environmental requirements, the light source of the backlight module has evolved from direct-type to the side-type. With the introduction of the side-type backlight module, a light guide plate with microstructure has been widely used. The micro-structural light guide plate is configured with a light-emitting surface having a plurality of grooves defined thereon. As a result, the light beam projected therethrough becomes more aligned. The efficiency of the micro-structural light guide plate is much better than those light guide plate with a merely planar light-emitting device.

In the liquid crystal display device, specially the large-scale liquid crystal display device, in order to prevent the displacement of the light guide plate with respect to the backframe, an interengagement therebetween has to be provided. FIG. 1 is an illustrational view showing several configurations in which engagement between a light guide plate and a backframe are shown. As shown in FIG. 1, the light-emitting device 2 of the light guide plate 1 is defined with a plurality of grooves 3 in parallel with each other. In FIG. 1a, a positioning portion 4 is provided at a side end of the light guide plate 1, and an anchor 6 is provided on the backframe 5 with respect to the positioning portion 4. With the interengagement between the positioning portion 4 and the anchor 6, the light guide plate 1 is attached onto the backframe 5. FIG. 1b illustrates a positioning portion 7 is provided on the side end, and on which a positioning hole 8 is defined. A dowel 9 is provided on the backframe 5 with respect to the positioning hole 8. With the interengagement between the positioning hole 8 and the dowel 9, the light guide plate 1 and the backframe 5 can be properly engaged. FIG. 1c illustrates a positioning hole 11 is defined on the side end of the light guide plate 1, and a dowel 12 is provided on the backframe 5 with respect to the positioning hole 11. With the interengagement between the positioning hole 11 and the dowel 12, the light guide plate 1 and the backframe 5 can be properly engaged.

However, as shown in FIGS. 1a-1c, because of the interengagement between the light guide plate 1 and the backframe 5, the grooves 3 defined on the light guide plate 1 have been inadequately damaged as when the light beam projects to the interengagement, the angle of the refraction of the light beam is tremendously diverted, for example, the transmitting direction of the light beam will be perpendicular to the extending direction of the grooves 3. In worse scenario, diffusion of the light beam could be happened. Once the diffusion of the light beam is further interacted with the grooves 3, a leakage of the light in the area of the interengagement of the light guide plate 1 of the backlight module could be encountered. As a result, the quality of the liquid crystal display device is compromised.

### SUMMARY OF THE INVENTION

In order to resolve the existing technologic problem, the present invention provides a liquid crystal display device which is equipped with a light guide plate, backlight module and liquid crystal display device which can effectively prevent leakage of light.

According to one aspect of the present invention, a light guide plate is provided and it includes an incident light surface for receiving a light beam projected therein, and a light exiting surface for directing the light beam out of the light guide plate, and a bottom surface opposite to the incident slight surface, wherein the incident light surface is perpendicular to the light exiting surface, and the light exiting surface is provided with a plurality of grooves, wherein the light guide plate further comprises a pair of side surfaces arranged on both sides of the light exiting surface, and the side surfaces are perpendicular to the incident light surface, wherein a longitudinal direction of the side surfaces is same as a direction of the grooves, and a distance between the side surfaces and the bottom surface is smaller than a distance between the light exiting surface and the bottom surface.

Further, wherein the distance between the side surface and the bottom surface and the distance between the light exiting surface and the bottom surface satisfy the following formula:

$$\frac{1}{3} \leq \frac{{T}_{Edge}}{{T}_{LGP}} \leq \frac{2}{3}$$

wherein T_{Edge} represents the distance between the side surface and the bottom surface, and T_{LGP} represents the distance between the light emitting surface and the bottom surface

Further, wherein a longitudinal direction of the incident light surface is perpendicular to the extending direction of the grooves.

Further, wherein the side surface is provided with a plurality of grooves.

According to another aspect of the present invention, a backlight module is provided and it comprises a light guide plate including an incident light surface for receiving a light beam projected therein, and a light exiting surface for directing the light beam out of the light guide plate, and a bottom surface opposite to the incident slight surface, wherein the incident light surface is perpendicular to the light exiting surface, and the light exiting surface is provided with a plurality of grooves, wherein the light guide plate further comprises a pair of side surfaces arranged on both sides of the light exiting surface, and the side surfaces are perpendicular to the incident light surface, wherein a longitudinal direction of the side surfaces is same as a direction of the grooves, and a distance between the side surfaces and the bottom surface is smaller than a distance between the light exiting surface and the bottom surface; a light source disposed in a position in adjacent to the incident surface of the light guide plate; and a backframe used to carry the light guide plate and the light source.

Further, wherein the distance between the side surface and the bottom surface and the distance between the light exiting surface and the bottom surface satisfy the following formula:

$$\frac{1}{3} \leq \frac{{T}_{Edge}}{{T}_{LGP}} \leq \frac{2}{3}$$

wherein T_{Edge} represents the distance between the side surface and the bottom surface, and T_{LGP} represents the distance between the light emitting surface and the bottom surface

Further, wherein a longitudinal direction of the incident light surface is perpendicular to the extending direction of the grooves.

Further, wherein the side surface is provided with a plurality of grooves.

Further, wherein the grooves disposed on the side surface are identical to the grooves disposed on the light-emitting surface.

Further, wherein the light source is a light bar configured with a power supplying circuit board and a plurality of dot-light mounted on the circuit board.

Further, wherein a lengthwise direction of the light source is perpendicular to the direction of the grooves.

Further, wherein a side end of the side surface is provided with a positioning portion and the backframe is provided with an anchoring portion with respect to the positioning portion of the side surface, with the interengagement between the positioning portion and the anchoring portion, the light guide plate can be readily and securely disposed onto an internal surface of the backframe.

According to another aspect of the present invention, a liquid crystal display device is provided and it includes a backlight module and a liquid crystal display panel disposed opposite to the backlight module which provides a light source to the liquid crystal display panel to produce displayable images thereon, wherein the backlight module comprises: a light guide plate including an incident light surface for receiving a light beam projected therein, and a light exiting surface for directing the light beam out of the light guide plate, and a bottom surface opposite to the incident slight surface, wherein the incident light surface is perpendicular to the light exiting surface, and the light exiting surface is provided with a plurality of grooves, wherein the light guide plate further comprises a pair of side surfaces arranged on both sides of the light exiting surface, and the side surfaces are perpendicular to the incident light surface, wherein a longitudinal direction of the side surfaces is same as a direction of the grooves, and a distance between the side surfaces and the bottom surface is smaller than a distance between the light exiting surface and the bottom surface; a light source disposed in a position in adjacent to the incident surface of the light guide plate; and a backframe used to carry the light guide plate and the light source.

Further, wherein the distance between the side surface and the bottom surface and the distance between the light exiting surface and the bottom surface satisfy the following formula:

$$\frac{1}{3} \leq \frac{{T}_{Edge}}{{T}_{LGP}} \leq \frac{2}{3}$$

wherein T_{Edge} represents the distance between the side surface and the bottom surface, and T_{LGP} represents the distance between the light emitting surface and the bottom surface

Further, wherein a longitudinal direction of the incident light surface is perpendicular to the extending direction of the grooves.

Further, wherein the side surface is provided with a plurality of grooves.

Further, wherein the grooves disposed on the side surface are identical to the grooves disposed on the light-emitting surface.

Further, wherein the light source is a light bar configured with a power supplying circuit board and a plurality of dot-light mounted on the circuit board.

Further, wherein the grooves disposed on the side surface are identical to the grooves disposed on the light-emitting surface.

Further, wherein a side end of the side surface is provided with a positioning portion and the backframe is provided with an anchoring portion with respect to the positioning portion of the side surface, with the interengagement between the positioning portion and the anchoring portion, the light guide plate can be readily and securely disposed onto an internal surface of the backframe.

By reducing thickness of the edge of the light guide plate, the difference between the light exiting surface and the side surface, the leakage of the light can be effectively avoided. Accordingly, quality of the display device can be improved.

### BRIEF DESCRIPTION OF DRAWINGS

FIG. 1 is an illustrational view showing several configurations in which engagement between a light guide plate and a backframe are shown;

FIG. 2 is an illustrational view showing a typical configuration of a liquid crystal display device;

FIG. 3 is an illustrational view showing a typical configuration of a backlight module;

FIG. 4 is a top view of a light source, a light guide plate and a backframe shown in FIG. 3;

FIG. 5 is a side view of the light guide plate shown in FIG. 3;

FIG. 6 is still a top view of a light source, a light guide plate and a backframe according to another embodiment of the present invention;

FIG. 7 is a side view of the light guide plate shown in FIG. 6.

### DETAILED DESCRIPTION OF PREFERRED EMBODIMENTS

In order clearly explain the technology of the embodiments illustrated in the present invention, a brief and concise description will be given along with the accompanied drawings. Apparently, the embodiments illustrated in the drawings are merely some typical embodiments, while should not be construed that the present invention can only be implemented in such manner. To the contrary, with the provision of the present invention, those embodiments will become more complete and thorough, and fully demonstrates the scope of the embodiments of the present invention to the skill in the art. In the accompanied drawings, identical element will be marked with same numeral reference.

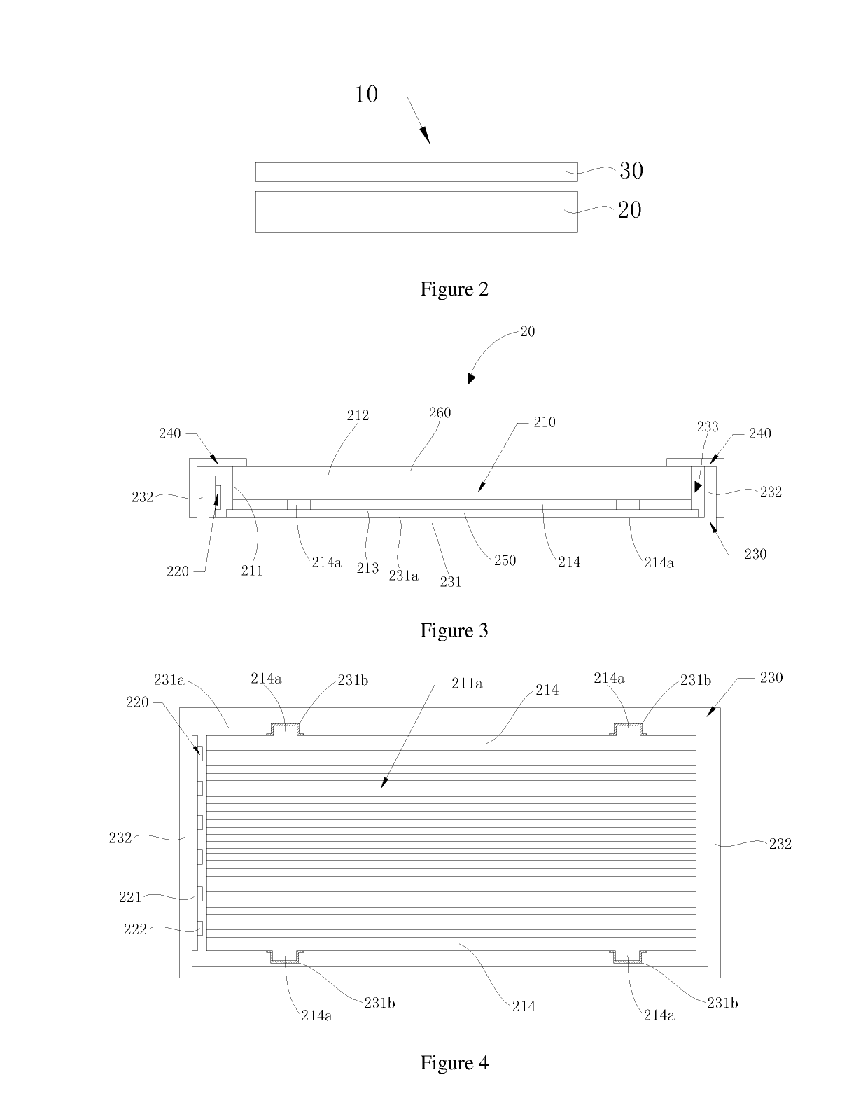

FIG. 2 is an illustrational view showing a typical configuration of a liquid crystal display device.

Referring to FIG. 2, according to a preferred embodiment of the liquid crystal display device 10 made in accordance of the present invention, it includes a backlight module 20, and a liquid crystal display panel 30 incorporated with the backlight module 20. The backlight module 20 provides light beam to the liquid crystal display panel 30 so as to display the images or pattern thereon.

Since the liquid crystal display panel 30 disclosed in the preferred embodiment of the present invention is identical to the existing liquid crystal display panel, accordingly, only a brief description is given herebelow. The liquid crystal display panel 30 made in accordance with the present invention generally includes a color filter substrate, a thin film transistor array substrate, and a layer of liquid crystal sandwiched between the color filter substrate and the thin film transistor array substrate. Wherein the liquid crystal layer includes a plurality of crystal molecules. The color filter substrate located opposite to the thin film transistor array substrate is also referred to as CF substrate (color filter substrate), and it generally includes a transparent substrate, such as a glass substrate, the black-dot patterns on the transparent substrate, color photo resister, such as red, green and blue photo resisters, and alignment layer. The thin film transistor array substrate which is opposite to the color filter substrate is also referred to as a TFT (thin film transistor) substrate, and it generally includes a transparent substrate, such as the glass substrate, and a plurality of thin film transistors arranged onto the transparent substrate in array. The main function of the thin film transistor array substrate is to provide energizing voltage to the liquid crystal molecules so as to align those liquid crystal molecules in a way that the light beam can pass through the liquid crystal layer. Finally, images or patterns can be readily displayed onto the liquid crystal panel 30 with the corporation of the color filter substrate.

A detailed description of the backlight module 20 made accordance with the preferred embodiment will be given herebelow.

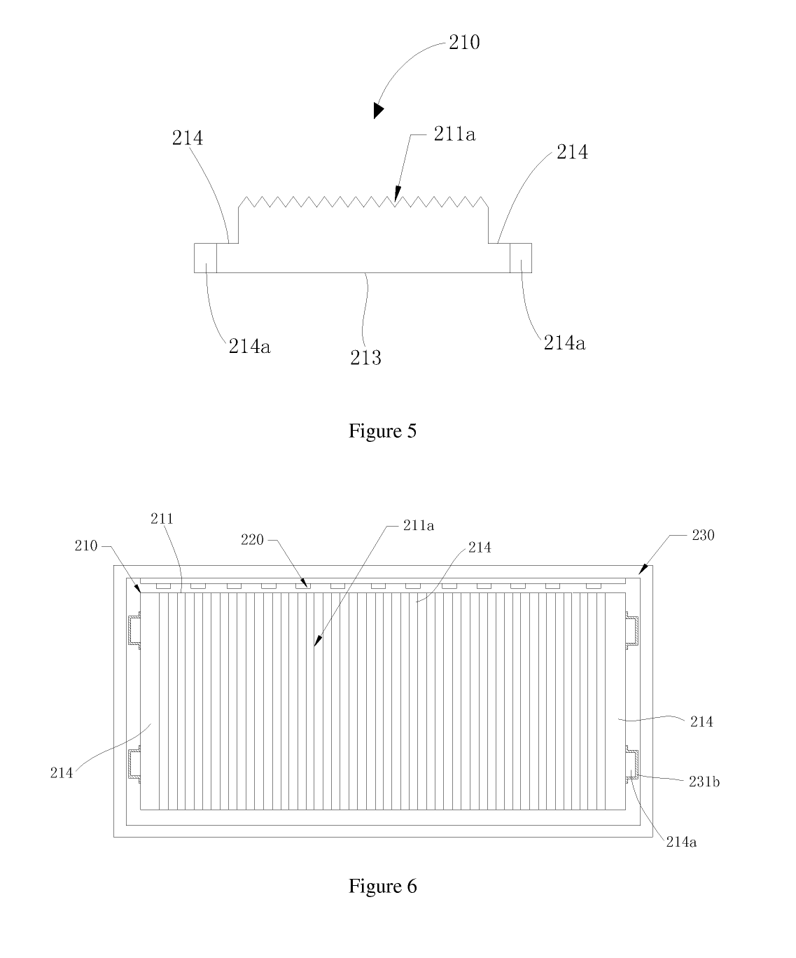

FIG. 3 is an illustrational view showing a typical configuration of a backlight module; FIG. 4 is a top view of a light source, a light guide plate and a backframe shown in FIG. 3; and FIG. 5 is a side view of the light guide plate shown in FIG. 3.

Referring to FIGS. 3 to 5, according the preferred embodiment, the backlight module 20 includes a light guide plate 210, a light source 220, a backframe 230, a middle frame 240, a refractor 250, and an optical film 260.

In the current embodiment, the light guide plate 210 has an oblong shape, while it should not be merely limited thereto. The light guide plate 210 includes a light incident surface 211, wherein the light incident surface 211 is a surface on the widthwise direction of the light guide plate 210. The light guide plate 210 further includes a light exiting surface 212, a bottom surface 213 opposite to the light incident surface 211, and a pair of side surfaces 214 which are located on side of the light incident surface 211, and extending along the lengthwise of the light guide plate 210, i.e. the length of the side surface 214 is substantially with the same direction of the light guide plate 210 or substantial consistent to the direction of the light guide plate 210. Wherein the light-emitting surface 212 is adjoining with the side surfaces 214 and the light incident surface 211, and the light-emitting surface 211 is defined with a plurality of grooves 211a with V-shaped cross section. The grooves 211a are arranged in parallel to each other. The direction of the V-shaped grooves 211a is substantially equivalent or consistent to the lengthwise direction of the light guide plate 210. The distance between the side surface 214 and the bottom surface 213 is smaller to the distance between the light exiting surface 212 and the bottom surface 213. In addition, the extending direction of the V-shaped groove 211a is perpendicular to the lengthwise direction of the light incident surface 211. It should be noted that the shape of the groove 211a is not limited to V-shaped only, and it can be any other shapes, such as the circular, semi-circular etc. In addition, as shown in FIG. 4, the extending direction of the grooves 211a is substantially equivalent or consistent to the lengthwise direction of the light guide plate 210. Each of the side surfaces 214 extends along the lengthwise direction of the light guide plate 210, and taking the surface on the widthwise of the light guide plate 210 as the light incident surface 211 are merely exemplar, instead of limitation to the present invention. For example, according to another embodiment of the present invention, the incident light surface 211 can be the side surface along the lengthwise of the light guide plate 210, and each of the side surfaces 214 can extend along the widthwise direction of the light guide plate 210. The extending direction of the groove 211a can be substantially equivalent or consistent to the widthwise direction of the light guide plate 210.

In the present embodiment, the light source 220 can be implemented and configured with a plurality of dot-light, for example, inorganic LED, organic LED, or a combination of the inorganic and organic LEDs mounted onto a power supplying circuit board 221, for example, a printed circuit board, PCB so as to create a light bar. The plurality of dot-light 222 are electrically interconnected with the circuit board 221. However, the present invention should not be limited thereto. For example, the light source 220 can be implemented with a light tube, such as a CCFL, cold-cathode fluorescent lamp, or a HCFL, hot-cathode fluorescent lamp.

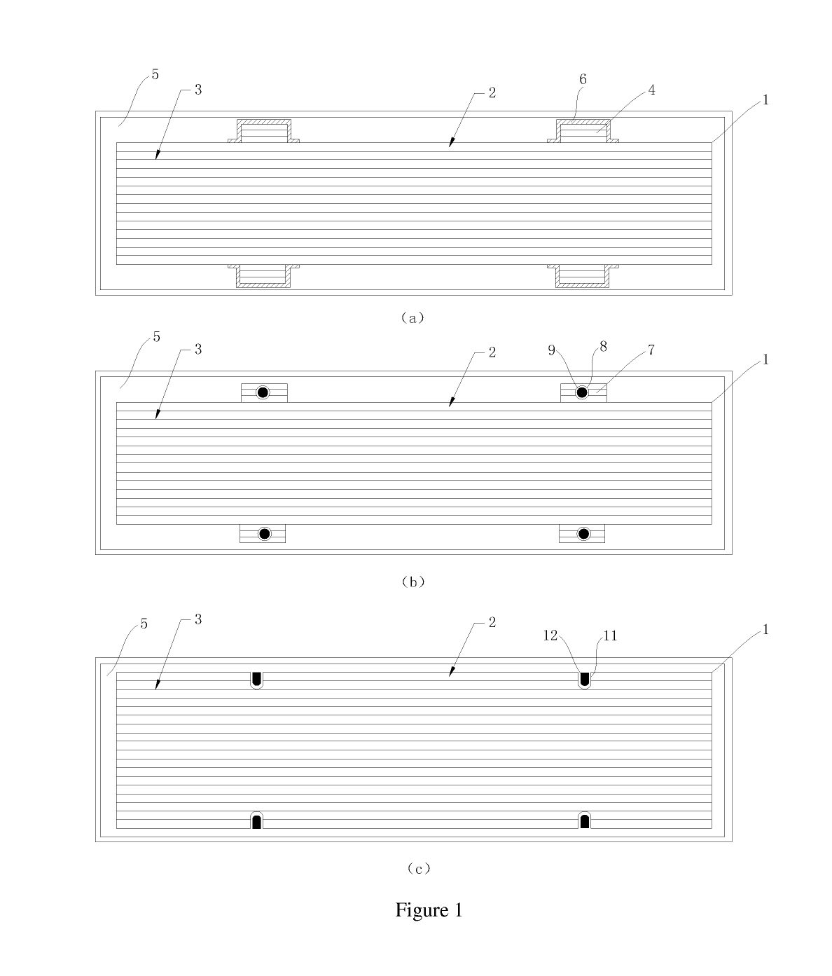

The backframe 230 includes a backboard 231 and which is bridged between two sidewalls 232 which are facing each other. A receiving space 233 is defined by the sidewalls 232 and the backboard 231 of the backframe 230. The light guide plate 210 is disposed within the receiving space 230 and the bottom surface 213 of the light guide plate 210 is disposed onto an internal surface 231a of the backboard 231. In order to prevent the light guide plate 210 from shifting tremendously across the internal surface 231a, the light guide plate 210 has to be securely positioned. As a result, two positioning portions 214a are arranged onto the ends of the side surfaces 214. The internal surface 231a of the backboard 231 are provided with anchors 231b corresponding to the positioning portions 214a so as to create an interengagement between the positioning portion 214a and the anchors 231b, thereby securely positioning the light guide plate 210 onto the internal surface 231a of the backboard 231. FIG. 4 illustrates another embodiment regarding the interengagement between the light guide plate 210 and the backframe 230, but this should not be construed as a limited implementation of the present invention, while merely an illustration. It should be noted that other preferred manner can be used as well. For example, referring to FIGS. 1b and 1c, the interengagement disclosed thereof. The light source 230 is disposed on one of the sidewalls 232 of the backframe 230 so as to closely dispose to the light incident surface 211 of the light guide plate 210. It means that the lengthwise direction of the light source 230 is perpendicular or substantially perpendicular to the extending direction of the grooves 211a. However, the present invention should not be limited thereto. For example, two separate light sources 230 can be arranged on each of the sidewalls 232 of the backframe 230, respectively. That means that the lengthwise direction of those two light sources 230 is perpendicular or substantially perpendicular to the extending direction of the grooves 211a. In addition, as discussed above and shown in FIG. 6, in another preferred embodiment of the present invention, when the light incident surface 211 is implemented as the side surface of the light guide plate 210, then each of the side surfaces 214 extends along the widthwise direction of the light guide plate 210, i.e. the lengthwise direction of each of the side surface 214 is consistent or substantially consistent to the widthwise direction of the light guide plate 210. When the extending direction of the grooves 211a is consistent or substantially consistent to the widthwise direction of the light guide plate 210, then the lengthwise direction of the light source 230 would be perpendicular or substantially perpendicular to the extending direction of the grooves 211a.

That means the lengthwise direction of the light source 230 is consistent or substantially consistent to the lengthwise direction of the light guide plate 210.

In addition, according to the preferred embodiment of the present invention, the middle frame 240 is made from plastic material, and can be integrally formed. The middle frame 210 is disposed on the light-emitting surface 212 of the light guide plate 210, and further engages with the sidewalls 232 of the backframe 230. By this arrangement, the light guide plate 210 and the light source 230 can be readily and securely secured. The refractor 250 is disposed between the bottom 213 of the light guide plate 210 and the internal surface 231a of the backboard 231 so as to redirect the light beam emitted from the bottom surface 213 of the light guide plate 210 back to the light guide plate 210 thereby increase the efficiency of the light beam. The refractor 250 can be configured with a single layer or multiple layers. It can be made from white material, refractive material or other suitable material. The optical film 260 is arranged between the light-emitting surface 212 of the light guide plate 210 and the middle frame 240 so as to improve the brightness, saturation and homogeneousness of the light beam emitted from the light-emitting surface 212 of the light guide plate 210 in a way to upgrade the display quality of the liquid crystal display panel. The optical film 260 is configured with brightness-enhanced film, diffusion film, and heavy-duty brightness enhanced film, polarizing film or a combination thereof. On the other hand, some specific optic film can provide at least two other optical functions, and it can be referred to as composite optical film. For example, some optical film is made to incorporate the polarizing/brightness enhancing, diffusion/brightness enhancing, and homogenizing/heavy-duty brightness enhancing, and polarizing/diffusion/brightness enhancing functions. As these are known to the skilled in the art and no detailed description given herebelow.

According to the preferred embodiment of the present invention, preferably, a distance between the side surface 214 and the bottom surface 213, and a distance between the light-emitting surface 212 and the bottom surface 213 satisfies the following formula:

$$\frac{1}{3} \leq \frac{{T}_{Edge}}{{T}_{LGP}} \leq \frac{2}{3}$$

wherein T_{Edge} represents the distance between the side surface 214 and the bottom surface 213, and T_{LGP} represents the distance between the light-emitting surface 212 and the bottom surface 213.

The above formula defines the rate between the distance of the side surfaces 214 and the bottom surface 213 and the distance between the light exiting surface 212 and the bottom surface 213. When the light beam is transmitted to the area adjacent to the side surfaces 214, the line of angle has been tremendously alerted, and even creates/generates diffusion. When it exceeds the lower limit, then it will be easy for the area of the light-emitting surface 212 to block the diffused light beam, or alternatively, redirecting the diffused light beam around the area of the side surfaces 214 so as to reenter into the light incident surface 212 to avoid the light leakage. However, since the distance between the side surfaces 214 and the bottom surface 213 is too short, it may readily cause a crack line between the side surfaces 214 and the bottom surface 213 and therefore damaging the light guide plate 210. When it exceeds the upper limit, then this ratio reinforce the rigidity between the side surface 214 and the light-emitting surface 212. As a result, the reliability of the light guide plate 210 is enhanced. However, this arrangement would be unlikely to have the area of the light-emitting surface 212 to block the diffused light beam, or it would be difficult to redirect the diffused light beam around the area of the side surfaces 214 back into the light incident surface 212. As a result, a light leakage will be encountered.

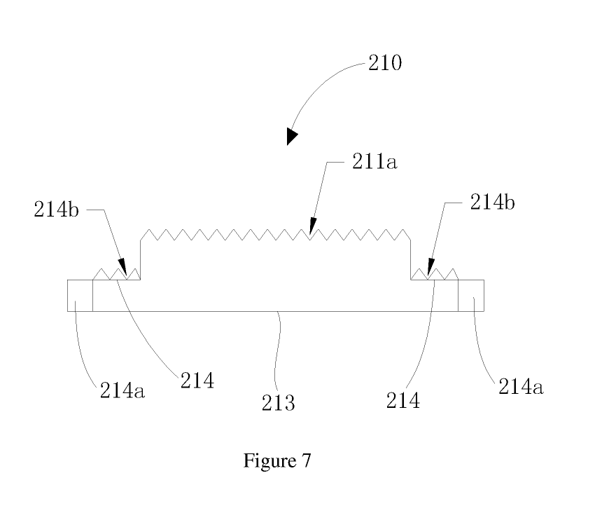

Preferably, in the preferred embodiment of the present invention, each of the side surfaces 214 does not define with a plurality of grooves in parallel with each other. However, the present invention will not be limited thereto. For example, such as shown in FIG. 7, according to another preferred embodiment of the present invention, each of the side surfaces 214 is defined with a plurality of grooves 214b in parallel with each other. The grooves 214b are identical to the V-shaped groove 211a, and each has a V-shaped cross section. It should be understood that the cross section of the grooves 214b can be any other suitable shapes, such as circular, semi-circle.

In conclusion, according to the preferred embodiments of the present invention, by reducing thickness of the edge of the light guide plate, the difference between the light exiting surface and the side surface, the leakage of the light can be effectively avoided. Accordingly, display quality of the liquid crystal display device can be improved.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the claims of the present invention.

1. A light guide plate including an incident light surface for receiving a light beam projected therein, and a light exiting surface for directing the light beam out of the light guide plate, and a bottom surface opposite to the incident slight surface, wherein the incident light surface is perpendicular to the light exiting surface, and the light exiting surface is provided with a plurality of grooves, wherein the light guide plate further comprises a pair of side surfaces arranged on both sides of the light exiting surface, and the side surfaces are perpendicular to the incident light surface, wherein a longitudinal direction of the side surfaces is same as a direction of the grooves, and a distance between the side surfaces and the bottom surface is smaller than a distance between the light exiting surface and the bottom surface.

2. The light guide plate as recited in claim 1, wherein the distance between the side surface and the bottom surface and the distance between the light exiting surface and the bottom surface satisfy the following formula:
$$\frac{1}{3} \leq \frac{{T}_{Edge}}{{T}_{LGP}} \leq \frac{2}{3}$$
wherein T_{Edge} represents the distance between the side surface and the bottom surface, and T_{LGP} represents the distance between the light emitting surface and the bottom surface.

3. The light guide plate as recited in claim 1, wherein a longitudinal direction of the incident light surface is perpendicular to the extending direction of the grooves.

4. The light guide plate as recited in claim 1, wherein the side surface is provided with a plurality of grooves.

5. The light guide plate as recited in claim 4, wherein the grooves disposed on the side surface are identical to the grooves disposed on the light-emitting surface.

6. A backlight module, comprising
a light guide plate including an incident light surface for receiving a light beam projected therein, and a light exiting surface for directing the light beam out of the light guide plate, and a bottom surface opposite to the incident slight surface, wherein the incident light surface is perpendicular to the light exiting surface, and the light exiting surface is provided with a plurality of grooves, wherein the light guide plate further comprises a pair of side surfaces arranged on both sides of the light exiting surface, and the side surfaces are perpendicular to the incident light surface, wherein a longitudinal direction of the side surfaces is same as a direction of the grooves, and a distance between the side surfaces and the bottom surface is smaller than a distance between the light exiting surface and the bottom surface;
a light source disposed in a position in adjacent to the incident surface of the light guide plate; and
a backframe used to carry the light guide plate and the light source.

7. The backlight module as recited in claim 6, wherein the distance between the side surface and the bottom surface and the distance between the light exiting surface and the bottom surface satisfy the following formula:
$$\frac{1}{3} \leq \frac{{T}_{Edge}}{{T}_{LGP}} \leq \frac{2}{3}$$
wherein T_{Edge} represents the distance between the side surface and the bottom surface, and T_{LGP} represents the distance between the light emitting surface and the bottom surface

8. The backlight module as recited in claim 6, wherein a longitudinal direction of the incident light surface is perpendicular to the extending direction of the grooves.

9. The backlight as recited in claim 6, wherein the side surface is provided with a plurality of grooves.

10. The backlight module as recited in claim 9, wherein the grooves disposed on the side surface are identical to the grooves disposed on the light-emitting surface.

11. The backlight module as recited in claim 4, wherein the light source is a light bar configured with a power supplying circuit board and a plurality of dot-light mounted on the circuit board.

12. The backlight module as recited in claim 11, wherein a lengthwise direction of the light source is perpendicular to the direction of the grooves.

13. The backlight module as recited in claim 6, wherein a side end of the side surface is provided with a positioning portion and the backframe is provided with an anchoring portion with respect to the positioning portion of the side surface, with the interengagement between the positioning portion and the anchoring portion, the light guide plate can be readily and securely disposed onto an internal surface of the backframe.

14. A liquid crystal display device, including a backlight module and a liquid crystal display panel disposed opposite to the backlight module which provides a light source to the liquid crystal display panel to produce displayable images thereon, wherein the backlight module comprises:
a light guide plate including an incident light surface for receiving a light beam projected therein, and a light exiting surface for directing the light beam out of the light guide plate, and a bottom surface opposite to the incident slight surface, wherein the incident light surface is perpendicular to the light exiting surface, and the light exiting surface is provided with a plurality of grooves, wherein the light guide plate further comprises a pair of side surfaces arranged on both sides of the light exiting surface, and the side surfaces are perpendicular to the incident light surface, wherein a longitudinal direction of the side surfaces is same as a direction of the grooves, and a distance between the side surfaces and the bottom surface is smaller than a distance between the light exiting surface and the bottom surface;
a light source disposed in a position in adjacent to the incident surface of the light guide plate; and
a backframe used to carry the light guide plate and the light source.

15. The liquid crystal display device as recited in claim 14, wherein the distance between the side surface and the bottom surface and the distance between the light exiting surface and the bottom surface satisfy the following formula:
$$\frac{1}{3} \leq \frac{{T}_{Edge}}{{T}_{LGP}} \leq \frac{2}{3}$$
wherein T_{Edge} represents the distance between the side surface and the bottom surface, and T_{LGP} represents the distance between the light emitting surface and the bottom surface

16. The liquid crystal display device as recited in claim 14, wherein a longitudinal direction of the incident light surface is perpendicular to the extending direction of the grooves.

17. The liquid crystal display device as recited in claim 14, wherein the side surface is provided with a plurality of grooves.

18. The liquid crystal display device as recited in claim 17, wherein the grooves disposed on the side surface are identical to the grooves disposed on the light-emitting surface.

19. The liquid crystal display device as recited in claim 14, wherein a lengthwise direction of the light source is perpendicular to the direction of the grooves.

20. The liquid crystal display device as recited in claim 14, wherein a side end of the side surface is provided with a positioning portion and the backframe is provided with an anchoring portion with respect to the positioning portion of the side surface, with the interengagement between the positioning portion and the anchoring portion, the light guide plate can be readily and securely disposed onto an internal surface of the backframe.
